(19) United States
(12) Patent Application Publication
(10) Pub. No.: US 2026/0133711 A1
(43) Pub. Date: May 14, 2026

(54) RESOURCE DISTRIBUTION IN MULTI-PORT MEMORY WITH HOST FEEDBACK

(71) Applicant: Micron Technology, Inc., Boise, ID (US)

(72) Inventors: Gaurav Sinha, Unterschleißheim (DE); Nicholas T. Heath, Pittsboro, NC (US)

(21) Appl. No.: 19/380,430

(22) Filed: Nov. 5, 2025

Related U.S. Application Data
(60) Provisional application No. 63/719,019, filed on Nov. 11, 2024.

(51) Int. Cl. G06F 3/06

(52) U.S. Cl. CPC G06F 3/0631; G06F 3/0613; G06F 3/0673

(57) ABSTRACT

Methods, systems, and devices for resource distribution in multi-port memory with host feedback are described. A multi-port memory system may allocate internal resources of a memory system to each of multiple ports of the memory system based on feedback from a host system. For example, the memory system may receive a resource utilization indication from one or more host systems that indicates an expected level of resource usage by each host system that is coupled with the memory system via a port. In some examples, the resource utilization indication may include an indicator of a relative intensity of input/output behavior by each of the host systems. In response to receiving the indication of resource utilization, the memory system may enter a port resource configuration mode and may re-allocate internal resources of the memory system to the one or more host systems in accordance with the received resource utilization indication.

### CROSS REFERENCE

The present application for patent claims priority to U.S. Patent Application No. 63/719,019 by Sinha et al., entitled “RESOURCE DISTRIBUTION IN MULTI-PORT MEMORY WITH HOST FEEDBACK,” filed Nov. 11, 2024, which is assigned to the assignee hereof, and which is expressly incorporated by reference in its entirety herein.

### TECHNICAL FIELD

The following relates to one or more systems for memory, including resource distribution in multi-port memory with host feedback.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports resource distribution in multi-port memory with host feedback in accordance with examples as disclosed herein.

FIG. 2 shows an example of an architecture that supports resource distribution in multi-port memory with host feedback in accordance with examples as disclosed herein.

FIG. 3 shows a block diagram of a memory system that supports resource distribution in multi-port memory with host feedback in accordance with examples as disclosed herein.

FIGS. 4 and 5 show flowcharts illustrating a method or methods that support resource distribution in multi-port memory with host feedback in accordance with examples as disclosed herein.

### DETAILED DESCRIPTION

Some memory systems (e.g., automotive systems) may utilize multiple ports for managing or executing commands from multiple external host systems (e.g., for multiple user applications) in parallel. For example, multiple external host systems may each be coupled with the memory system via the multiple ports (e.g., a respective external host system may be coupled with a memory system through a respective port) and may utilize resources at the memory system for execution of application-specific commands. A memory system controller may allocate a respective portion of internal resources of the memory system to each of the multiple ports, and each port may utilize the respective portion of internal resources for execution of an application. The internal resources may include command slots for storage of commands received from a host system, area in a logical-to-physical (L2P) cache, area in a volatile memory, or firmware table sizes, among other examples. In some examples, the internal resources for allocation may be evenly distributed across the ports such that each port of the multiple ports is allocated an equal portion of the internal resources. However, an actual usage of the internal resources (e.g., for input/output (I/O) operations) by host systems coupled at the ports may be more intensive by some of the host systems than others. Accordingly, there may be a mismatch between the resource allocation across the multiple ports, which may be an even distribution, and a level (e.g., an amount) of resource utilization by each of the host systems at a respective port. Such a mismatch between the resource allocation and the corresponding resource utilization at each of the multiple ports may result in an inefficient utilization of resources within the memory system, which may result in performance losses and increased latencies.

In accordance with examples described herein, a multi-port memory system (e.g., a multi-port solid state drive (SSD), such as an automotive SSD, among other examples) may allocate internal resources of the memory system to each of the multiple ports based on feedback from a host system. For example, the memory system may receive a resource utilization indication from one or more host systems that indicates an expected level of resource usage by each of one or more host systems that are coupled with the memory system via the ports. In some examples, the resource utilization indication may include an indicator of a relative intensity of I/O behavior (e.g., I/O requirements) by each of the host systems. In response to receiving the indication from the one or more host systems, the memory system may enter a port resource configuration mode and may re-allocate a set of internal resources of the memory system to each of the one or more host systems in accordance with the received resource utilization indication. By allocating resources to more closely correspond with the indicated utilizations (e.g., or expected utilizations) of host systems that are serviced by the memory system via the multiple ports, the memory system may support increased performance and reduced latencies, in particular for relatively more intensive I/O applications. In some examples, the memory system may represent an example of or otherwise be included within an automotive system (e.g., an automotive SSD), and the techniques described herein for resource distribution in multi-port memory with host feedback may improve efficient utilization of resources within the automotive system, thereby increasing performance and reducing latency for automotive applications, among other examples.

In addition to applicability in memory systems as described herein, techniques for resource distribution in multi-port memory with host feedback may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by improving memory access speeds), which may decrease processing or latency times, improve response times, or otherwise improve user experience, among other benefits. Additionally, the memory system may be implemented within an automotive system (e.g., an automotive SSD), and may thereby support increased performance for execution of automotive applications within the automotive system.

Features of the disclosure are illustrated and described in the context of systems, devices, and circuits. Features of the disclosure are further illustrated and described in the context of architectures, block diagrams, and flowcharts.

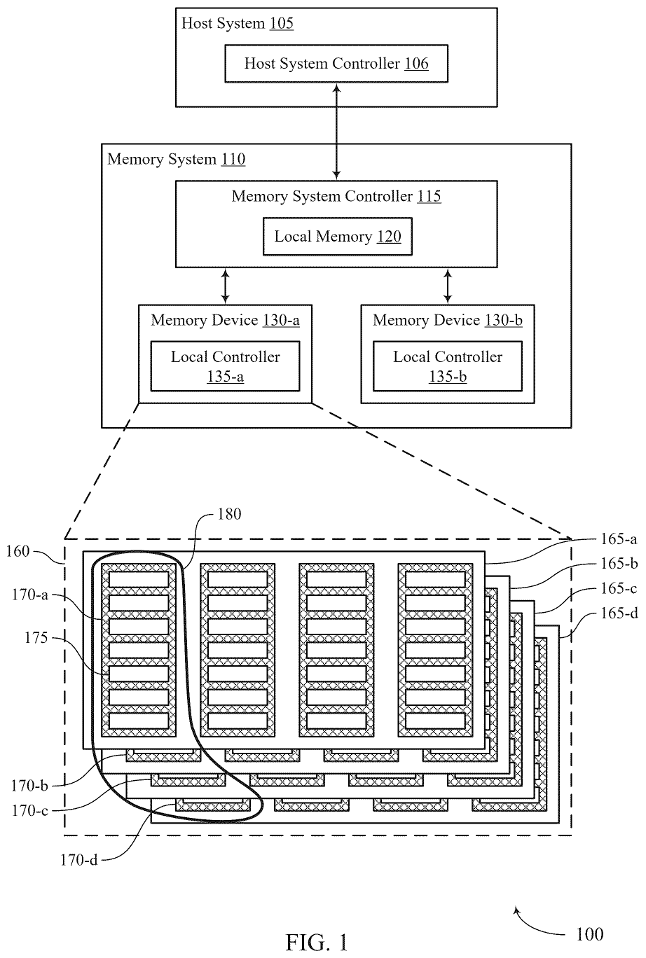

FIG. 1 shows an example of a system 100 that supports resource distribution in multi-port memory with host feedback in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b. A local controller 135 may be or include a microcontroller, special purpose logic circuitry (e.g., a field programmable gate array (FPGA), an application specific integrated circuit (ASIC), a digital signal processor (DSP)), or any other suitable processor or processing circuitry.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

Some memory systems 110 (e.g., in automotive systems) may utilize multiple ports for managing or executing commands from multiple external host systems 105 (e.g., for multiple user applications) in parallel. For example, multiple external host systems 105 may each be coupled with the memory system 110 via the multiple ports (e.g., a respective external host system 105 may be coupled with a memory system 110 through a respective port) and may utilize resources at the memory system 110 for execution of application-specific commands. A memory system controller 115 may allocate a respective portion of internal resources of the memory system 110 (e.g., of local memory 120, of memory devices 130) to each of the multiple ports, and each port may utilize the respective portion of internal resources for execution of an application. The internal resources may include command slots for storage of commands received from a host system 105, area in an L2P cache in the local memory 120, area in a volatile memory in the local memory 120 or in the memory devices 130, or firmware table sizes, among other examples. In some examples, the internal resources for allocation may be evenly distributed across the ports such that each port of the multiple ports is allocated an equal portion of the internal resources. However, an actual usage of the internal resources (e.g., for I/O operations) by host systems 105 coupled at the ports of the memory system 110 may be more intensive by some of the host systems 105 than others. Accordingly, there may be a mismatch between the resource allocation across the multiple ports, which may be an even distribution, and a level (e.g., an amount) of resource utilization by each of the host systems 105 at a respective port. Such a mismatch between the resource allocation and the corresponding resource utilization at each of the multiple ports may result in an inefficient utilization of resources within the memory system 110, which may result in performance losses and increased latencies.

In accordance with examples described herein, a multi-port memory system 110 (e.g., a multi-port SSD, such as an automotive SSD, among other examples) may allocate internal resources of the memory system 110 to each of the multiple ports based on feedback from a host system 105. For example, the memory system 110 may receive a resource utilization indication from one or more host systems 105 that indicates an expected level of resource usage by each of one or more host systems 105 that are coupled with the memory system 110 via the ports. In some examples, the resource utilization indication may include an indicator of a relative intensity of I/O behavior (e.g., I/O requirements) by each of the host systems 105. In response to receiving the indication from the one or more host systems 105, the memory system 110 may enter a port resource configuration mode and may re-allocate a set of internal resources of the memory system 110 to each of the one or more host systems in accordance with the received resource utilization indication. By allocating resources to more closely correspond with the indicated utilizations (e.g., or expected utilizations) of host systems 105 that are serviced by the memory system 110 via the multiple ports, the memory system 110 may support increased performance and reduced latencies, in particular for relatively more intensive I/O applications. In some examples, the memory system 110 may represent an example of or otherwise be included within an automotive system (e.g., an automotive SSD), and the techniques described herein for resource distribution in multi-port memory with host feedback may improve efficient utilization of resources within the automotive system, thereby increasing performance and reducing latency for automotive applications, among other examples.

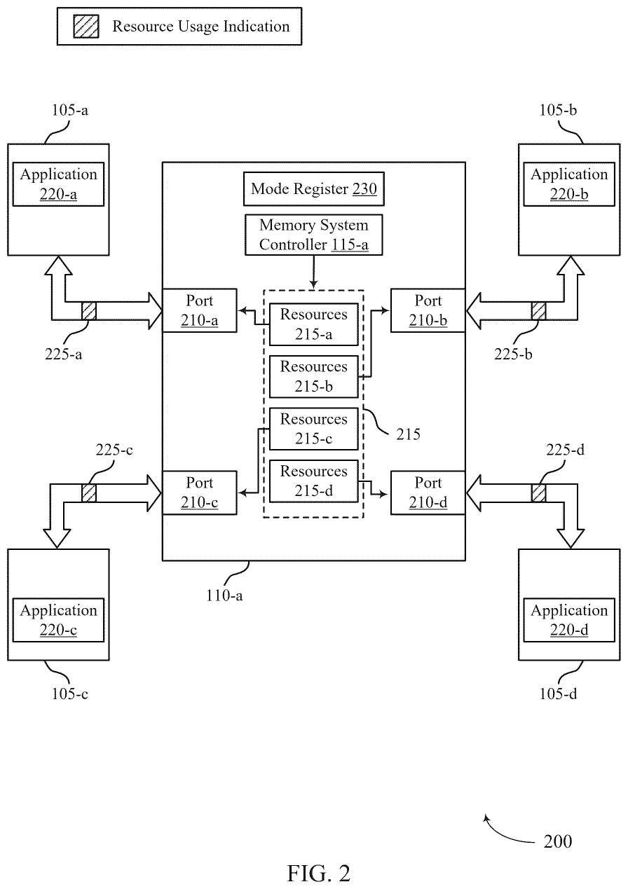

FIG. 2 shows an example of an architecture 200 that supports resource distribution in multi-port memory with host feedback in accordance with examples as disclosed herein. The architecture 200 may implement or may be implemented by aspects of the system 100. For example, the architecture 200 may include a memory system 110-a, a host system 105-a, a host system 105-b, a host system 105-c, and a host system 105-d, which may be examples of corresponding devices described herein.

The memory system 110-a may be a multi-ported memory system and may include a port 210-a, a port 210-b, a port 210-c, and a port 210-d. The ports 210 may allow for multiple host systems 105 to establish connections with the memory system 110-a and to execute commands using the memory system 110-a for executing applications 220 (e.g., or functions). For example, a host system 105-a may be coupled with the memory system 110-a via the port 210-a and may host (e.g., and may execute commands for) an application 220-a (e.g., advanced driver-assistance system (ADAS)). A host system 105-b may be coupled with the memory system 110-a via the port 210-b and may host an application 220-b (e.g., infotainment), a host system 105-c may be coupled with the memory system 110-a via the port 210-c and may host an application 220-c (e.g., navigation), and a host system 105-d may be coupled with the memory system 110-a via the port 210-d and may host an application 220-d (e.g., telematics). Although the architecture 200 illustrates four host systems 105 and four ports 210, it is to be understood that a memory system may include any quantity and combination of ports and host systems, including four of each, or any other quantities. Additionally, or alternatively, the host systems 105 each may support any type or quantity of one or more applications 220, including the example applications 220 described herein, or other types of applications. The memory system 110-a may include one or more memory arrays across one or more memory devices that store data for the execution of the various applications. The ports may provide an interface for communicating commands and data with the host systems 105, but the actual data for each host system 105 may be stored in various locations within the memory system 110-a.

In some examples, a memory system controller 115-a of the memory system 110-a may allocate a respective portion of internal resources 215 of the memory system 110-a to each of the ports 210 for servicing commands from the host systems 105. The allocation of resources 215 to each of the multiple ports 210 of the memory system 110-a may occur during a manufacturing process or during a bootup (e.g., power on) of the memory system 110-a. In some cases, the memory system controller 115-a may allocate an equal portion of resources 215 from a set (e.g., pool) of internal resources 215 available to the memory system 110-a to each port 210 to serve the various host systems 105 coupled at the ports 210. For example, the port 210-a may be allocated resources 215-a, the port 210-b may be allocated resources 215-b, the port 210-c may be allocated resources 215-c, and the port 210-d may be allocated resources 215-d. According to the equal distribution of resources 215 for allocation to the various ports 210, the resources 215-a, the resources 215-b, the resources 215-c, and the resources 215-d may each include a same quantity (e.g., amount, portion) of internal resources 215.

In the example of Table 1, the memory system 110-a may have a total quantity of command slots (e.g., 1024) that the memory system 110-a supports for storage of commands from the host systems 105. A command slot may represent an example of a resource for storing (e.g., buffering, queuing) one or more received commands. In some cases, a memory system may, upon a startup or bootup of the memory system or otherwise as a default configuration, divide the total quantity of command slots evenly between four ports 210 such that the host system 105-a that hosts an ADAS application 220-a is allocated a first quantity of command slots (e.g., 256) from the total quantity, the host system 105-b that hosts an infotainment application 220-b is allocated the same first quantity of command slots (e.g., 256), the host system 105-c that hosts a navigation application 220-c is allocated the same first quantity of command slots (e.g., 256), and the host system 105-d that hosts a telematics application 220-d is allocated the same first quantity of command slots (e.g., 256). Quantities of command slots is one example of internal resources 215 that may be allocated by a memory system controller to the various ports 210, but other examples of internal resources 215 for allocation are also possible. For example, the internal resources 215 may include area in an L2P cache, area in a volatile memory, or firmware table sizes, among other examples.

TABLE 1
Example Resource Allocation in a Multi-Port System

| | Command Slots | Host Expected |
|---|---|---|
| Host System | Allocated | Queue Depth |
| ADAS | 256 | >256 |
| Infotainment | 256 | <256 (e.g., 64) |
| Navigation | 256 | <256 (e.g., 64) |
| Telematics | 256 | <256 (e.g., 16) |

In such cases, if the memory system controller allocates the internal resources 215 with an even (e.g., equal) distribution across the ports 210 of the memory system, an actual usage of the internal resources 215 by each of the host systems 105 may vary. For example, some host systems 105 may correspond to applications 220 with a relatively intensive I/O workload (e.g., quantity of commands, quantity of I/O operations) while other host systems 105 correspond to applications 220 with a relatively less intensive I/O workload. In some cases, the host systems 105 may be capable of predicting a characteristic (e.g., a parameter, a rating) of I/O operations performed by the host system 105 during service of the application 220 or a level (e.g., high, medium, low) of resource utilization (e.g., of internal resources 215) by the host system 105 during operation of the memory system 110-a. In the example of Table 1, the host system 105-a may correspond to an expected queue depth that exceeds a threshold quantity (e.g., 256 commands), which may exceed a capability of the port 210-a based on the even distribution of resources 215 across the ports 210 of the memory system 110-a. One or more of the host system 105-b, the host system 105-c, and the host system 105-d, on the other hand, may correspond to an expected queue depth that is less than the threshold quantity (e.g., 256 commands), which may be below a capability of the port 210-b, the port 210-c, and/or the port 210-d based on the even distribution of resources 215 across the ports 210. In these and other examples where the capabilities of the ports 210 are misaligned with the expected utilizations of host systems 105 coupled with the ports 210, the memory system may lack efficient resource utilization.

In accordance with examples described herein, the memory system 110-a (e.g., the memory system controller 115-a) may perform allocation of resources 215 based on feedback from one or more host systems 105 that indicates an expected resource usage (e.g., I/O parameter, level of operation) by host systems 105 at each port 210 of the multi-ported memory system 110-a. In some examples, the expected resource usage by the host systems 105 may be written (e.g., by one or multiple host systems 105) to a mode register 230. In some examples, the port 210-b may be a management port (e.g., a resource management port). In such examples, the host system 105-a coupled with the port 210-b may transmit, via the port 210-b, a resource usage indication 225-b that indicates a respective resource usage (e.g., level of operation) by each of one or more host systems 105 at ports 210. The resource usage indication 225-b may indicate a first resource usage by the host system 105-a at the port 210-a and may indicate one or more second resource usages by other host systems 105 at other ports 210. The resource usage indication 225-a may be transmitted from a management controller (e.g., a management operating system) of the host system 105-b.

Additionally, or alternatively, the memory system 110-a may receive a respective resource usage indication 225 (e.g., an indicator of expected resource usage) from each host system 105 that indicates a respective usage of resources (e.g., level of operation) of the host system 105 from which the resource usage indication 225 is received. In an example, the memory system 110-a may receive a resource usage indication 225-a via the port 210-a that indicates a resource usage of the application 220-a (e.g., infotainment), may receive a resource usage indication 225-b via the port 210-b that indicates a resource usage of the application 220-b (e.g., ADAS), may receive a resource usage indication 225-c via the port 210-c that indicates a resource usage of the application 220-c (e.g., telematics), and may receive a resource usage indication 225-d via the port 210-d that indicates a resource usage of the application 220-d (e.g., navigation).

In some examples, the resource usage indications 225 may include a respective percentage (e.g., or quantity) of the set of internal resources 215 that is predicted to be used (e.g., or is historically used) by each host system 105. In some examples, the resource usage indications 225 may indicate a relative intensity of resource utilization corresponding to each host system 105. For example, the resource usage indications 225 may indicate a respective level of operation by each host system 105 from a set of candidate levels of operation (e.g., intensive, moderate, low) based on one or more thresholds associated with each candidate level of operation. In an example, the host system 105-a may correspond to an ‘intensive’ level of operations, the host system 105-b and the host system 105-c may correspond to a ‘moderate’ level of operation, and the host system 105-d may correspond to a ‘low’ level of operation. Additionally, or alternatively, the resource usage indications 225 may assign each port 210 a weight value indicative of a relative intensity of resource utilization at the corresponding port. In some examples, the resource usage indications 225 may indicate or be based on a respective quantity of I/O commands (e.g., an expected queue depth) for execution of applications 220 by the host systems 105.

The memory system 110-a may enter a port resource configuration mode based on receiving the one or more resource usage indications 225 from one or more host systems 105 and may perform an allocation of a set of internal resources 215 of the memory system 110-a to the ports 210 based on the feedback from the host systems 105. In some examples, the memory system 110-a may enter the port resource configuration mode during a boot-up sequence (e.g., power up, reset) of the memory system 110-a. The bootup sequence may, in some cases, establish a connection between the memory system 110-a and the host systems 105 via one or more ports 210. The memory system 110-a may monitor (e.g., during the boot-up sequence) one or more first values stored in the mode register 230 that indicate for the memory system 110-a to enter the port resource configuration mode and one or more second values of the mode register 230 that indicate the resource usage indicators for the various ports 210. The memory system 110-a may enter the port resource configuration mode based on the one or more first values of the mode register 230 or the one or more second values of the mode register 230, or both.

The memory system 110-a in the port resource configuration mode may allocate a respective portion of resources 215 from a set of total internal resources 215 at the memory system 110-a to each port 210 of the multiple ports 210 in accordance with the expected (e.g., indicated) usage of resources by the multiple host systems 105. For example, the memory system 110-a may allocate resources 215-a to the port 210-a based on an expected usage of resources by the host system 105-a, may allocate resources 215-b to the port 210-b based on an expected usage of resources by the host system 105-b, may allocate resources 215-c to the port 210-c based on an expected usage of resources by the host system 105-c, and may allocate resources 215-d to the port 210-d based on an expected usage of resources by the host system 105-d. In some examples, a first amount of the resources 215-a (e.g., 50% of the set of total resources 215) may be greater than a second amount of the resources 215-b (e.g., 20% of the set of total resources 215) based on a first expected usage of resources indicated for the host system 105-a being greater than a second expected usage of resources indicated for the host system 105-b. In some examples, a third amount of the resources 215-d (e.g., 10% of the set of total resources 215) may be less than the first amount of the resources 215-a and less than the second amount of the resources 215-b based on a third expected usage of resources indicated for the host system 105-d being less than the first expected usage of resources and the second expected usage of resources. The port resource configuration mode may thereby include a mode in which the memory system 110-a may not support regular access operations for accessing data stored in the memory system 110-a and may instead pause such operations to re-allocate resources 215 between the ports 210. As described herein, the resources 215 may include resources 215 for operating the ports and executing host applications 220. However, it is to be understood that the memory system 110-a may include one or more other resources, such as memory cells, arrays, and the like, for storing data associated with the one or more host systems 105, among other types of data and metadata.

In some examples, based on the memory system 110-a completing the allocation of the resources 215 to the various ports 210, the memory system 110-a may enter an operational mode (e.g., may switch from the port resource configuration mode to the operational mode). In the operational mode, the memory system 110-a may receive commands from the host systems 105 and may execute functions according to the commands and using the respective portions of resources 215 that the memory system 110-a has allocated. For example, the memory system 110-a may execute, by the port 210-a based on switching to the operational mode, functions requested by the host system 105-a using the resources 215-a allocated to the port 210-a. In like manner, the memory system 110-a may execute, by the port 210-b, functions requested by the host system 105-b using the resources 215-b allocated to the port 210-b, may execute, by the port 210-c, functions requested by the host system 105-c using the resources 215-c, and may execute, by the port 210-d, functions requested by the host system 105-d using the resources 215-d. In some examples, the resources 215-a, the resources 215-b, the resources 215-c, and the resources 215-d may each include a respective quantity of command slots from a total quantity of command slots supported by the memory system 110-a, a respective portion of a cache area of a cache (e.g., L2P cache) of the memory system 110-a, a respective portion of volatile memory from volatile memory (e.g., a DRAM) of the memory system 110-a, or a respective size of a firmware table associated with firmware of the memory system 110-a. The cache, the volatile memory (e.g., the DRAM), or both may be for storage of metadata or firmware information associated with operations by the ports 210 (e.g., during execution of applications 220).

In some examples, executing the access operations may include using the resources 215 allocated to a given port 210 to identify and access data stored within a certain location within the memory system 110-a, based on the access command.

The memory system 110-a may thereby support communication of feedback (e.g., the resource usage indication(s) 225) with one or more host systems 105, where the feedback may indicate relative levels of I/O usage that are predicted for each host system 105. The memory system 110-a may re-allocate resources 215 to various ports 210 of the memory system 110-a based on the feedback, which may improve resource allocation and performance of various applications 220 by the memory system 110-a. In some examples, the memory system 110-a may receive the feedback and perform the resource allocation during a bootup operation. Additionally, or alternatively, the memory system 110-a may dynamically receive the feedback and re-allocate resources during operation.

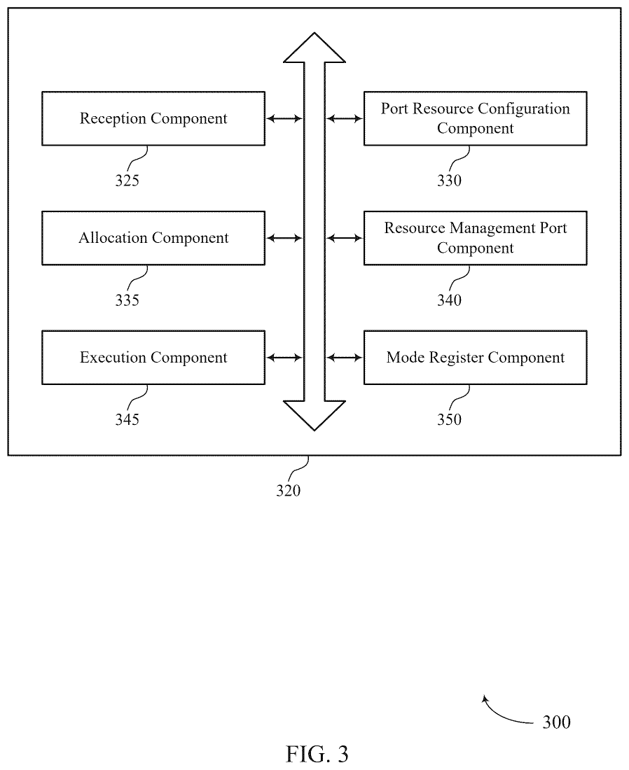

FIG. 3 shows a block diagram 300 of a memory system 320 that supports resource distribution in multi-port memory with host feedback in accordance with examples as disclosed herein. The memory system 320 may be an example of aspects of a memory system as described with reference to FIGS. 1 through 2. The memory system 320, or various components thereof, may be an example of means for performing various aspects of resource distribution in multi-port memory with host feedback as described herein. For example, the memory system 320 may include a reception component 325, a port resource configuration component 330, an allocation component 335, a resource management port component 340, an execution component 345, a mode register component 350, or any combination thereof. Each of these components, or components of subcomponents thereof (e.g., one or more processors, one or more memories), may communicate, directly or indirectly, with one another (e.g., via one or more buses).

The reception component 325 may be configured as or otherwise support a means for receiving, via one or more ports of a plurality of ports of the memory system, an indication of an expected usage of resources by a plurality of host systems, where one or more ports of the plurality of ports are coupled with a respective host system of the plurality of host systems. The port resource configuration component 330 may be configured as or otherwise support a means for entering a port resource configuration mode of the memory system based on the indication of the expected usage of resources by the plurality of host systems. The allocation component 335 may be configured as or otherwise support a means for allocating, based on the port resource configuration mode of the memory system, a plurality of resources of the memory system to the plurality of ports of the memory system, where the one or more ports of the plurality of ports are each allocated a respective portion of resources of the plurality of resources of the memory system in accordance with the indication of the expected usage of resources by the plurality of host systems.

In some examples, to support receiving the indication of the expected usage of resources by the plurality of host systems, the reception component 325 may be configured as or otherwise support a means for receiving, at the one or more ports of the plurality of ports and from a respective host system of the plurality of host systems, a respective indicator of expected usage corresponding to each respective port of the plurality of ports, where allocating the respective portion of resources to the one or more ports is in accordance with the respective indicator of expected usage corresponding to each port of the plurality of ports.

In some examples, to support receiving the indication of the expected usage of resources by the plurality of host systems, the reception component 325 may be configured as or otherwise support a means for receiving, from a first host system of the plurality of host systems and via a first port of the plurality of ports, the indication of the expected usage of resources by the plurality of host systems that indicates a respective expected usage of resources corresponding to each port of the plurality of ports of the memory system.

In some examples, to support receiving the indication of the expected usage of resources by the plurality of host systems, the reception component 325 may be configured as or otherwise support a means for receiving, from a first host system of the plurality of host systems and via a first port of the plurality of ports of the memory system, a first indication of a first expected usage of resources by the first host system corresponding to the first port of the plurality of ports. In some examples, to support receiving the indication of the expected usage of resources by the plurality of host systems, the reception component 325 may be configured as or otherwise support a means for receiving, from a second host system of the plurality of host systems and via a second port of the plurality of ports of the memory system, a second indication of a second expected usage of resources by the second host system corresponding to the second port of the plurality of ports.

In some examples, to support allocating the plurality of resources to the plurality of ports, the allocation component 335 may be configured as or otherwise support a means for allocating a first set of resources of the plurality of resources to the first port in accordance with the first indication. In some examples, to support allocating the plurality of resources to the plurality of ports, the allocation component 335 may be configured as or otherwise support a means for allocating a second set of resources of the plurality of resources to the second port in accordance with the second indication, where the second set of resources includes more resources than the first set of resources based on the second expected usage of resources indicated via the second indication being greater than the first expected usage of resources indicated via the first indication.

In some examples, to support allocating the plurality of resources of the memory system to the plurality of ports of the memory system, the allocation component 335 may be configured as or otherwise support a means for allocating, based on the indication of the expected usage of resources, a respective quantity of command slots of a plurality of command slots associated with the memory system to each port of the one or more ports, where the plurality of resources includes the plurality of command slots for storage of commands received from the plurality of host systems.

In some examples, to support allocating the plurality of resources of the memory system to the plurality of ports of the memory system, the allocation component 335 may be configured as or otherwise support a means for allocating, based on the indication of the expected usage of resources, a respective portion of a cache area associated with a cache of the memory system, a respective portion of volatile memory of the memory system, or both to each port of the one or more ports, where the plurality of resources includes the cache area of the cache of the memory system, the volatile memory of the memory system, or both for storage of metadata, firmware information, or both associated with the plurality of ports.

In some examples, to support entering the port resource configuration mode of the memory system, the port resource configuration component 330 may be configured as or otherwise support a means for entering the port resource configuration mode during a boot-up sequence associated with the plurality of host systems.

In some examples, the indication of the expected usage of resources includes a percentage of resources associated with each host system of the plurality of host systems, an intensity of resource utilization associated with each host system of the plurality of host systems, or any combination thereof.

The resource management port component 340 may be configured as or otherwise support a means for receiving, at a resource management port of the memory system and from a first host system coupled with the resource management port, a resource usage indication that indicates, for each host system of a plurality of host systems coupled with the memory system, a respective level of operation associated with each host system. In some examples, the allocation component 335 may be configured as or otherwise support a means for allocating, while operating in a port resource configuration mode and based on the resource usage indication received at the resource management port, a first quantity of resources of the memory system to a first port of a plurality of ports of the memory system, the first port coupled with a second host system of the plurality of host systems, the first quantity of resources being based on the resource usage indication indicating a first level of operation associated with the second host system. The execution component 345 may be configured as or otherwise support a means for executing, by the first port based on switching from the port resource configuration mode to an operational mode of the memory system, one or more functions requested by the second host system using the first quantity of resources allocated to the first port.

In some examples, the allocation component 335 may be configured as or otherwise support a means for allocating, while operating in the port resource configuration mode and based on the resource usage indication received at the resource management port, a second quantity of resources of the memory system to a second port of the plurality of ports of the memory system, the second port coupled with a third host system of the plurality of host systems, where the second quantity of resources is based on the resource usage indication indicating a second level of operation associated with the third host system.

In some examples, the execution component 345 may be configured as or otherwise support a means for executing, by the second port based on switching from the port resource configuration mode to the operational mode, one or more second functions requested by the third host system using the second quantity of resources allocated to the second port.

In some examples, the second quantity of resources is greater than the first quantity of resources based on the second level of operation associated with the third host system being greater than the first level of operation associated with the second host system.

In some examples, the allocation component 335 may be configured as or otherwise support a means for allocating, while operating in the port resource configuration mode and based on the resource usage indication received at the resource management port, a second quantity of resources of the memory system to the resource management port, where the second quantity of resources is based on the resource usage indication indicating a second level of operation associated with the first host system.

In some examples, to support receiving the resource usage indication at the resource management port, the mode register component 350 may be configured as or otherwise support a means for monitoring one or more values of a mode register, where the one or more values of the mode register indicate the resource usage indication.

In some examples, the respective level of operation associated with each host system of the plurality of host systems and indicated via the resource usage indication is one of a plurality of candidate levels of operation.

In some examples, the respective level of operation associated with each host system of the plurality of host systems and indicated via the resource usage indication is based on a quantity of I/O commands associated with execution of applications by each host system.

In some examples, to support allocating the first quantity of resources of the memory system to the first port, the allocation component 335 may be configured as or otherwise support a means for allocating, to the first port based on the resource usage indication, a first portion of command slots of a plurality of command slots associated with the memory system, where the plurality of command slots are for storage of commands received from the plurality of host systems.

In some examples, to support allocating the first quantity of resources of the memory system to the first port, the allocation component 335 may be configured as or otherwise support a means for allocating, to the first port based on the resource usage indication, a first portion of a cache area associated with a cache of the memory system, a first portion of volatile memory of the memory system, or both, where the cache area, the volatile memory, or both are for storage of metadata, firmware information, or both associated with the plurality of ports.

In some examples, the described functionality of the memory system 320, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 320, or various components thereof, may be implemented at least in part by instructions (e.g., stored in memory, non-transitory computer-readable medium) executable by such at least one processor.

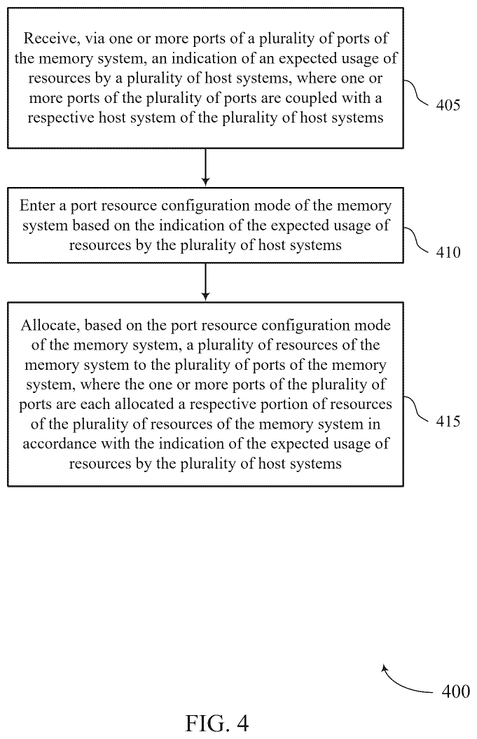

FIG. 4 shows a flowchart illustrating a method 400 that supports resource distribution in multi-port memory with host feedback in accordance with examples as disclosed herein. The operations of method 400 may be implemented by a memory system or its components as described herein. For example, the operations of method 400 may be performed by a memory system as described with reference to FIGS. 1 through 3. In some examples, a memory system may execute a set of instructions to control the functional elements of the device to perform the described functions. Additionally, or alternatively, the memory system may perform aspects of the described functions using special-purpose hardware.

At 405, the method may include receiving, via one or more ports of a plurality of ports of the memory system, an indication of an expected usage of resources by a plurality of host systems, where one or more ports of the plurality of ports are coupled with a respective host system of the plurality of host systems. The operations of 405 may be performed in accordance with examples as disclosed herein. For example, the memory system may include one or more mode registers (e.g., the mode register 230 of FIG. 2) that is configured to store the indication of the expected usage based on indications (e.g., the indications 225 of FIG. 2) from one or more host systems. In some examples, aspects of the operations of 405 may be performed by a reception component 325 as described with reference to FIG. 3.

At 410, the method may include entering a port resource configuration mode of the memory system based on the indication of the expected usage of resources by the plurality of host systems. The operations of 410 may be performed in accordance with examples as disclosed herein. For example, the memory system may include a memory system controller (e.g., the memory system controller 115 of FIGS. 1 and 2) that is configured to adjust or otherwise change an operating mode of the memory system to enter the port resource configuration mode. In some examples, aspects of the operations of 410 may be performed by a port resource configuration component 330 as described with reference to FIG. 3.

At 415, the method may include allocating, based on the port resource configuration mode of the memory system, a plurality of resources of the memory system to the plurality of ports of the memory system, where the one or more ports of the plurality of ports are each allocated a respective portion of resources of the plurality of resources of the memory system in accordance with the indication of the expected usage of resources by the plurality of host systems. The operations of 415 may be performed in accordance with examples as disclosed herein. For example, the memory system may include a memory system controller (e.g., the memory system controller 115 of FIGS. 1 and 2) that is configured to allocate internal resources (e.g., the resources 215 of FIG. 2) to one or more ports (e.g., the ports 210 of FIG. 2). In some examples, aspects of the operations of 415 may be performed by an allocation component 335 as described with reference to FIG. 3.

In some examples, an apparatus as described herein may perform a method or methods, such as the method 400. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving, via one or more ports of a plurality of ports of the memory system, an indication of an expected usage of resources by a plurality of host systems, where one or more ports of the plurality of ports are coupled with a respective host system of the plurality of host systems; entering a port resource configuration mode of the memory system based on the indication of the expected usage of resources by the plurality of host systems; and allocating, based on the port resource configuration mode of the memory system, a plurality of resources of the memory system to the plurality of ports of the memory system, where the one or more ports of the plurality of ports are each allocated a respective portion of resources of the plurality of resources of the memory system in accordance with the indication of the expected usage of resources by the plurality of host systems.

Aspect 2: The method, apparatus, or non-transitory computer-readable medium of aspect 1, where receiving the indication of the expected usage of resources by the plurality of host systems includes operations, features, circuitry, logic, means, or instructions, or any combination thereof for receiving, at the one or more ports of the plurality of ports and from a respective host system of the plurality of host systems, a respective indicator of expected usage corresponding to each respective port of the plurality of ports, where allocating the respective portion of resources to the one or more ports is in accordance with the respective indicator of expected usage corresponding to each port of the plurality of ports.

Aspect 3: The method, apparatus, or non-transitory computer-readable medium of any of aspects 1 through 2, where receiving the indication of the expected usage of resources by the plurality of host systems includes operations, features, circuitry, logic, means, or instructions, or any combination thereof for receiving, from a first host system of the plurality of host systems and via a first port of the plurality of ports, the indication of the expected usage of resources by the plurality of host systems that indicates a respective expected usage of resources corresponding to each port of the plurality of ports of the memory system.

Aspect 4: The method, apparatus, or non-transitory computer-readable medium of any of aspects 1 through 3, where receiving the indication of the expected usage of resources by the plurality of host systems includes operations, features, circuitry, logic, means, or instructions, or any combination thereof for receiving, from a first host system of the plurality of host systems and via a first port of the plurality of ports of the memory system, a first indication of a first expected usage of resources by the first host system corresponding to the first port of the plurality of ports and receiving, from a second host system of the plurality of host systems and via a second port of the plurality of ports of the memory system, a second indication of a second expected usage of resources by the second host system corresponding to the second port of the plurality of ports.

Aspect 5: The method, apparatus, or non-transitory computer-readable medium of aspect 4, where allocating the plurality of resources to the plurality of ports includes operations, features, circuitry, logic, means, or instructions, or any combination thereof for allocating a first set of resources of the plurality of resources to the first port in accordance with the first indication and allocating a second set of resources of the plurality of resources to the second port in accordance with the second indication, where the second set of resources includes more resources than the first set of resources based on the second expected usage of resources indicated via the second indication being greater than the first expected usage of resources indicated via the first indication.

Aspect 6: The method, apparatus, or non-transitory computer-readable medium of any of aspects 1 through 5, where allocating the plurality of resources of the memory system to the plurality of ports of the memory system includes operations, features, circuitry, logic, means, or instructions, or any combination thereof for allocating, based on the indication of the expected usage of resources, a respective quantity of command slots of a plurality of command slots associated with the memory system to each port of the one or more ports, where the plurality of resources includes the plurality of command slots for storage of commands received from the plurality of host systems.

Aspect 7: The method, apparatus, or non-transitory computer-readable medium of any of aspects 1 through 6, where allocating the plurality of resources of the memory system to the plurality of ports of the memory system includes operations, features, circuitry, logic, means, or instructions, or any combination thereof for allocating, based on the indication of the expected usage of resources, a respective portion of a cache area associated with a cache of the memory system, a respective portion of volatile memory of the memory system, or both to each port of the one or more ports, where the plurality of resources includes the cache area of the cache of the memory system, the volatile memory of the memory system, or both for storage of metadata, firmware information, or both associated with the plurality of ports.

Aspect 8: The method, apparatus, or non-transitory computer-readable medium of any of aspects 1 through 7, where entering the port resource configuration mode of the memory system includes operations, features, circuitry, logic, means, or instructions, or any combination thereof for entering the port resource configuration mode during a boot-up sequence associated with the plurality of host systems.

Aspect 9: The method, apparatus, or non-transitory computer-readable medium of any of aspects 1 through 8, where the indication of the expected usage of resources includes a percentage of resources associated with each host system of the plurality of host systems, an intensity of resource utilization associated with each host system of the plurality of host systems, or any combination thereof.

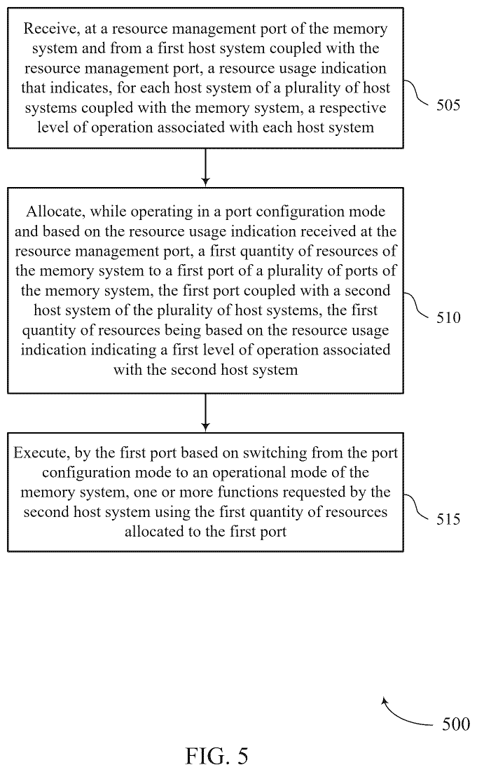

FIG. 5 shows a flowchart illustrating a method 500 that supports resource distribution in multi-port memory with host feedback in accordance with examples as disclosed herein. The operations of method 500 may be implemented by a memory system or its components as described herein. For example, the operations of method 500 may be performed by a memory system as described with reference to FIGS. 1 through 3. In some examples, a memory system may execute a set of instructions to control the functional elements of the device to perform the described functions. Additionally, or alternatively, the memory system may perform aspects of the described functions using special-purpose hardware.

At 505, the method may include receiving, at a resource management port of the memory system and from a first host system coupled with the resource management port, a resource usage indication that indicates, for each host system of a plurality of host systems coupled with the memory system, a respective level of operation associated with each host system. The operations of 505 may be performed in accordance with examples as disclosed herein. For example, the memory system may include one or more mode registers (e.g., the mode register 230 of FIG. 2) that is configured to store the indication of the expected usage based on indications (e.g., the indications 225 of FIG. 2) from one or more host systems. In some examples, aspects of the operations of 505 may be performed by a resource management port component 340 as described with reference to FIG. 3.

At 510, the method may include allocating, while operating in a port resource configuration mode and based on the resource usage indication received at the resource management port, a first quantity of resources of the memory system to a first port of a plurality of ports of the memory system, the first port coupled with a second host system of the plurality of host systems, the first quantity of resources being based on the resource usage indication indicating a first level of operation associated with the second host system. The operations of 510 may be performed in accordance with examples as disclosed herein. For example, the memory system may include a memory system controller (e.g., the memory system controller 115 of FIGS. 1 and 2) that is configured to allocate internal resources (e.g., the resources 215 of FIG. 2) to one or more ports (e.g., the ports 210 of FIG. 2). In some examples, aspects of the operations of 510 may be performed by an allocation component 335 as described with reference to FIG. 3.

At 515, the method may include executing, by the first port based on switching from the port resource configuration mode to an operational mode of the memory system, one or more functions requested by the second host system using the first quantity of resources allocated to the first port. The operations of 515 may be performed in accordance with examples as disclosed herein. For example, the memory system may include a first port (e.g., resource management port, such as the port 210-a of FIG. 2) that is configured to execute functions (e.g., access operations) requested by a host system (e.g., the host system 105-a of FIG. 2) using resources allocated to the port (e.g., the resources 215-a of FIG. 2). In some examples, aspects of the operations of 515 may be performed by an execution component 345 as described with reference to FIG. 3.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 10: A method, apparatus, or non-transitory computer-readable medium including operations, features, circuitry, logic, means, or instructions, or any combination thereof for receiving, at a resource management port of the memory system and from a first host system coupled with the resource management port, a resource usage indication that indicates, for each host system of a plurality of host systems coupled with the memory system, a respective level of operation associated with each host system; allocating, while operating in a port resource configuration mode and based on the resource usage indication received at the resource management port, a first quantity of resources of the memory system to a first port of a plurality of ports of the memory system, the first port coupled with a second host system of the plurality of host systems, the first quantity of resources being based on the resource usage indication indicating a first level of operation associated with the second host system; and executing, by the first port based on switching from the port resource configuration mode to an operational mode of the memory system, one or more functions requested by the second host system using the first quantity of resources allocated to the first port.

Aspect 11: The method, apparatus, or non-transitory computer-readable medium of aspect 10, further including operations, features, circuitry, logic, means, or instructions, or any combination thereof for allocating, while operating in the port resource configuration mode and based on the resource usage indication received at the resource management port, a second quantity of resources of the memory system to a second port of the plurality of ports of the memory system, the second port coupled with a third host system of the plurality of host systems, where the second quantity of resources is based on the resource usage indication indicating a second level of operation associated with the third host system.

Aspect 12: The method, apparatus, or non-transitory computer-readable medium of aspect 11, further including operations, features, circuitry, logic, means, or instructions, or any combination thereof for executing, by the second port based on switching from the port resource configuration mode to the operational mode, one or more second functions requested by the third host system using the second quantity of resources allocated to the second port.

Aspect 13: The method, apparatus, or non-transitory computer-readable medium of aspect 12, where the second quantity of resources is greater than the first quantity of resources based on the second level of operation associated with the third host system being greater than the first level of operation associated with the second host system.

Aspect 14: The method, apparatus, or non-transitory computer-readable medium of any of aspects 10 through 13, further including operations, features, circuitry, logic, means, or instructions, or any combination thereof for allocating, while operating in the port resource configuration mode and based on the resource usage indication received at the resource management port, a second quantity of resources of the memory system to the resource management port, where the second quantity of resources is based on the resource usage indication indicating a second level of operation associated with the first host system.

Aspect 15: The method, apparatus, or non-transitory computer-readable medium of any of aspects 10 through 14, where receiving the resource usage indication at the resource management port includes operations, features, circuitry, logic, means, or instructions, or any combination thereof for monitoring one or more values of a mode register, where the one or more values of the mode register indicate the resource usage indication.

Aspect 16: The method, apparatus, or non-transitory computer-readable medium of any of aspects 10 through 15, where the respective level of operation associated with each host system of the plurality of host systems and indicated via the resource usage indication is one of a plurality of candidate levels of operation.

Aspect 17: The method, apparatus, or non-transitory computer-readable medium of any of aspects 10 through 16, where the respective level of operation associated with each host system of the plurality of host systems and indicated via the resource usage indication is based on a quantity of I/O commands associated with execution of applications by each host system.

Aspect 18: The method, apparatus, or non-transitory computer-readable medium of any of aspects 10 through 17, where allocating the first quantity of resources of the memory system to the first port includes operations, features, circuitry, logic, means, or instructions, or any combination thereof for allocating, to the first port based on the resource usage indication, a first portion of command slots of a plurality of command slots associated with the memory system, where the plurality of command slots are for storage of commands received from the plurality of host systems.

Aspect 19: The method, apparatus, or non-transitory computer-readable medium of any of aspects 10 through 18, where allocating the first quantity of resources of the memory system to the first port includes operations, features, circuitry, logic, means, or instructions, or any combination thereof for allocating, to the first port based on the resource usage indication, a first portion of a cache area associated with a cache of the memory system, a first portion of volatile memory of the memory system, or both, where the cache area, the volatile memory, or both are for storage of metadata, firmware information, or both associated with the plurality of ports.

It should be noted that the described techniques include possible implementations, and that the operations and the steps may be rearranged or otherwise modified and that other implementations are possible. Further, portions from two or more of the methods may be combined.

An apparatus is described. The following provides an overview of aspects of the apparatus as described herein:

Aspect 20: A memory system, including: one or more memory arrays; a resource management port coupled with a first host system of a plurality of host systems; a plurality of ports coupled with one or more second host systems of the plurality of host systems; one or more mode registers coupled with the first host system, the one or more mode registers configured to receive, from the first host system, an indication of resource usage by the plurality of host systems; and processing circuitry configured to adjust an allocation of a plurality of memory resources associated with the memory system to the plurality of ports based on the indication of resource usage by the plurality of host systems.

Aspect 21: The memory system of aspect 20, where the indication of the resource usage by the plurality of host systems indicates a respective level of operation associated with each host system of the plurality of host systems.

Aspect 22: The memory system of aspect 21, where the respective level of operation associated with each host system of the plurality of host systems and indicated via the one or more mode registers is one of a plurality of candidate levels of operation.

Aspect 23: The memory system of any of aspects 21 through 22, where the respective level of operation associated with each host system of the plurality of host systems and indicated via the one or more mode registers is based on a quantity of I/O commands associated with execution of applications by each host system.

Aspect 24: The memory system of any of aspects 21 through 23, where to adjust the allocation of the plurality of memory resources to the plurality of ports, the processing circuitry is configured to allocate a respective portion of the plurality of memory resources to one or more ports of the plurality of ports based on the indication of the resource usage by the plurality of host systems.

Aspect 25: The memory system of any of aspects 20 through 24, where: one or more command queues for storage of commands received from the plurality of host systems, the one or more command queues including a plurality of command slots, where the plurality of memory resources includes the plurality of command slots, and where adjusting the allocation of the plurality of memory resources to the plurality of ports includes allocating a respective quantity of the plurality of command slots to one or more ports of the plurality of ports.

Aspect 26: The memory system of any of aspects 20 through 25, where: at least one memory array of the one or more memory arrays includes volatile memory for storage of metadata, firmware information, or both associated with the plurality of ports; the plurality of memory resources includes the volatile memory; and to adjust the allocation of the plurality of memory resources to the plurality of ports, the processing circuitry is further configured to allocate a respective portion of the volatile memory to one or more ports of the plurality of ports.

Aspect 27: The memory system of any of aspects 20 through 26, where the processing circuitry is further configured to cause the memory system to enter a port resource configuration mode of the memory system based on the indication of the resource usage by the plurality of host systems, adjusting the allocation of the plurality of memory resources is based on entering the port resource configuration mode.

Aspect 28: The memory system of any of aspects 20 through 27, where the processing circuitry is further configured to cause the memory system to enter a port resource configuration mode of the memory system during a bootup sequence with the first host system, adjusting the allocation of the plurality of memory resources is during the bootup sequence with the first host system.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
receive, via one or more ports of a plurality of ports of the memory system, an indication of an expected usage of resources by a plurality of host systems, wherein one or more ports of the plurality of ports are coupled with a respective host system of the plurality of host systems;
enter a port resource configuration mode of the memory system based on the indication of the expected usage of resources by the plurality of host systems; and
allocate, based on the port resource configuration mode of the memory system, a plurality of resources of the memory system to the plurality of ports of the memory system, wherein the one or more ports of the plurality of ports are each allocated a respective portion of resources of the plurality of resources of the memory system in accordance with the indication of the expected usage of resources by the plurality of host systems.

2. The memory system of claim 1, wherein receiving the indication of the expected usage of resources by the plurality of host systems comprises the processing circuitry configured to cause the memory system to:
receive, at the one or more ports of the plurality of ports and from a respective host system of the plurality of host systems, a respective indicator of expected usage corresponding to each respective port of the plurality of ports, wherein allocating the respective portion of resources to the one or more ports is in accordance with the respective indicator of expected usage corresponding to each port of the plurality of ports.

3. The memory system of claim 1, wherein receiving the indication of the expected usage of resources by the plurality of host systems comprises the processing circuitry configured to cause the memory system to:
receive, from a first host system of the plurality of host systems and via a first port of the plurality of ports, the indication of the expected usage of resources by the plurality of host systems that indicates a respective expected usage of resources corresponding to each port of the plurality of ports of the memory system.

4. The memory system of claim 1, wherein receiving the indication of the expected usage of resources by the plurality of host systems comprises the processing circuitry configured to cause the memory system to:
receive, from a first host system of the plurality of host systems and via a first port of the plurality of ports of the memory system, a first indication of a first expected usage of resources by the first host system corresponding to the first port of the plurality of ports; and
receive, from a second host system of the plurality of host systems and via a second port of the plurality of ports of the memory system, a second indication of a second expected usage of resources by the second host system corresponding to the second port of the plurality of ports.

5. The memory system of claim 4, wherein allocating the plurality of resources to the plurality of ports comprises the processing circuitry configured to cause the memory system to:
allocate a first set of resources of the plurality of resources to the first port in accordance with the first indication; and
allocate a second set of resources of the plurality of resources to the second port in accordance with the second indication, wherein the second set of resources comprises more resources than the first set of resources based on the second expected usage of resources indicated via the second indication being greater than the first expected usage of resources indicated via the first indication.

6. The memory system of claim 1, wherein allocating the plurality of resources of the memory system to the plurality of ports of the memory system comprises the processing circuitry configured to cause the memory system to:
allocate, based on the indication of the expected usage of resources, a respective quantity of command slots of a plurality of command slots associated with the memory system to each port of the one or more ports, wherein the plurality of resources comprises the plurality of command slots for storage of commands received from the plurality of host systems.

7. The memory system of claim 1, wherein allocating the plurality of resources of the memory system to the plurality of ports of the memory system comprises the processing circuitry configured to cause the memory system to:
allocate, based on the indication of the expected usage of resources, a respective portion of a cache area associated with a cache of the memory system, a respective portion of volatile memory of the memory system, or both to each port of the one or more ports, wherein the plurality of resources comprises the cache area of the cache of the memory system, the volatile memory of the memory system, or both for storage of metadata, firmware information, or both associated with the plurality of ports.

8. The memory system of claim 1, wherein entering the port resource configuration mode of the memory system comprises the processing circuitry configured to cause the memory system to:
enter the port resource configuration mode during a boot-up sequence associated with the plurality of host systems.

9. The memory system of claim 1, wherein the indication of the expected usage of resources comprises a percentage of resources associated with each host system of the plurality of host systems, an intensity of resource utilization associated with each host system of the plurality of host systems, or any combination thereof.

10. A memory system, comprising:
one or more memory devices; and
processing circuitry coupled with the one or more memory devices and configured to cause the memory system to:
receive, at a resource management port of the memory system and from a first host system coupled with the resource management port, a resource usage indication that indicates, for each host system of a plurality of host systems coupled with the memory system, a respective level of operation associated with each host system;
allocate, while operating in a port resource configuration mode and based on the resource usage indication received at the resource management port, a first quantity of resources of the memory system to a first port of a plurality of ports of the memory system, the first port coupled with a second host system of the plurality of host systems, the first quantity of resources being based on the resource usage indication indicating a first level of operation associated with the second host system; and
execute, by the first port based on switching from the port resource configuration mode to an operational mode of the memory system, one or more functions requested by the second host system using the first quantity of resources allocated to the first port.

11. The memory system of claim 10, wherein the processing circuitry is further configured to cause the memory system to:
allocate, while operating in the port resource configuration mode and based on the resource usage indication received at the resource management port, a second quantity of resources of the memory system to a second port of the plurality of ports of the memory system, the second port coupled with a third host system of the plurality of host systems, wherein the second quantity of resources is based on the resource usage indication indicating a second level of operation associated with the third host system.

12. The memory system of claim 11, wherein the processing circuitry is further configured to cause the memory system to:
execute, by the second port based on switching from the port resource configuration mode to the operational mode, one or more second functions requested by the third host system using the second quantity of resources allocated to the second port.

13. The memory system of claim 11, wherein the second quantity of resources is greater than the first quantity of resources based on the second level of operation associated with the third host system being greater than the first level of operation associated with the second host system.

14. The memory system of claim 10, wherein the processing circuitry is further configured to cause the memory system to:
allocate, while operating in the port resource configuration mode and based on the resource usage indication received at the resource management port, a second quantity of resources of the memory system to the resource management port, wherein the second quantity of resources is based on the resource usage indication indicating a second level of operation associated with the first host system.

15. The memory system of claim 10, wherein receiving the resource usage indication at the resource management port comprises the processing circuitry configured to cause the memory system to:
monitor one or more values of a mode register, wherein the one or more values of the mode register indicate the resource usage indication.

16. The memory system of claim 10, wherein the respective level of operation associated with each host system of the plurality of host systems and indicated via the resource usage indication is one of a plurality of candidate levels of operation.

17. The memory system of claim 10, wherein the respective level of operation associated with each host system of the plurality of host systems and indicated via the resource usage indication is based on a quantity of input/output (I/O) commands associated with execution of applications by each host system.

18. The memory system of claim 10, wherein allocating the first quantity of resources of the memory system to the first port comprises the processing circuitry configured to cause the memory system to:
allocate, to the first port based on the resource usage indication, a first portion of command slots of a plurality of command slots associated with the memory system, wherein the plurality of command slots are for storage of commands received from the plurality of host systems.

19. The memory system of claim 10, wherein allocating the first quantity of resources of the memory system to the first port comprises the processing circuitry configured to cause the memory system to:
allocate, to the first port based on the resource usage indication, a first portion of a cache area associated with a cache of the memory system, a first portion of volatile memory of the memory system, or both, wherein the cache area, the volatile memory, or both are for storage of metadata, firmware information, or both associated with the plurality of ports.

20. A memory system, comprising:
one or more memory arrays;
a resource management port coupled with a first host system of a plurality of host systems;
a plurality of ports coupled with one or more second host systems of the plurality of host systems;
one or more mode registers coupled with the first host system, the one or more mode registers configured to receive, from the first host system, an indication of resource usage by the plurality of host systems; and
processing circuitry configured to adjust an allocation of a plurality of memory resources associated with the memory system to the plurality of ports based on the indication of resource usage by the plurality of host systems.

21. The memory system of claim 20, wherein the indication of the resource usage by the plurality of host systems indicates a respective level of operation associated with each host system of the plurality of host systems.

22. The memory system of claim 21, wherein the respective level of operation associated with each host system of the plurality of host systems and indicated via the one or more mode registers is one of a plurality of candidate levels of operation.

23. The memory system of claim 21, wherein the respective level of operation associated with each host system of the plurality of host systems and indicated via the one or more mode registers is based on a quantity of input/output (I/O) commands associated with execution of applications by each host system.

24. The memory system of claim 20, wherein, to adjust the allocation of the plurality of memory resources to the plurality of ports, the processing circuitry is configured to allocate a respective portion of the plurality of memory resources to one or more ports of the plurality of ports based on the indication of the resource usage by the plurality of host systems.

25. The memory system of claim 20, further comprising:
one or more command queues for storage of commands received from the plurality of host systems, the one or more command queues comprising a plurality of command slots, wherein the plurality of memory resources comprises the plurality of command slots, and wherein adjusting the allocation of the plurality of memory resources to the plurality of ports comprises allocating a respective quantity of the plurality of command slots to one or more ports of the plurality of ports.

26. The memory system of claim 20, wherein:
at least one memory array of the one or more memory arrays comprises volatile memory for storage of metadata, firmware information, or both associated with the plurality of ports;
the plurality of memory resources comprises the volatile memory; and
to adjust the allocation of the plurality of memory resources to the plurality of ports, the processing circuitry is further configured to allocate a respective portion of the volatile memory to one or more ports of the plurality of ports.

27. The memory system of claim 20, wherein the processing circuitry is further configured to cause the memory system to enter a port resource configuration mode of the memory system based on the indication of the resource usage by the plurality of host systems, wherein adjusting the allocation of the plurality of memory resources is based on entering the port resource configuration mode.

28. The memory system of claim 20, wherein the processing circuitry is further configured to cause the memory system to enter a port resource configuration mode of the memory system during a bootup sequence with the first host system, wherein adjusting the allocation of the plurality of memory resources is during the bootup sequence with the first host system.

29. A method by a memory system, comprising:
receiving, via one or more ports of a plurality of ports of the memory system, an indication of an expected usage of resources by a plurality of host systems, wherein one or more ports of the plurality of ports are coupled with a respective host system of the plurality of host systems;
entering a port resource configuration mode of the memory system based on the indication of the expected usage of resources by the plurality of host systems; and
allocating, based on switching to the port resource configuration mode of the memory system, a plurality of resources of the memory system to the plurality of ports of the memory system, wherein the one or more ports of the plurality of ports are each allocated a respective portion of resources of the plurality of resources of the memory system in accordance with the indication of the expected usage of resources by the plurality of host systems.

30. A method by a memory system, comprising:
receiving, at a resource management port of the memory system and from a first host system coupled with the resource management port, a resource usage indication that indicates, for each host system of a plurality of host systems coupled with the memory system, a respective level of operation associated with each host system;
allocating, while operating in a port resource configuration mode and based on the resource usage indication received at the resource management port, a first quantity of resources of the memory system to a first port of a plurality of ports of the memory system, the first port coupled with a second host system of the plurality of host systems, the first quantity of resources being based on a first level of operation associated with the second host system and indicated via the resource usage indication; and
executing, by the first port based on switching from the port resource configuration mode to an operational mode of the memory system, one or more functions requested by the first host
system using the first quantity of resources allocated to the first port.
